(19) United States
(12) Patent Application Publication
(10) Pub. No.: US 2026/0153942 A1
(43) Pub. Date: Jun. 4, 2026

(54) ELECTRONIC DEVICE AND OPERATION METHOD FOR CALIBRATING IMAGE DISPLAY SETTINGS ACROSS MULTIPLE MONITORS

(71) Applicant: SAMSUNG ELECTRONICS CO., LTD., Suwon-si (KR)

(72) Inventors: Hoon CHOI, Suwon-si (KR); Junhee WOO, Suwon-si (KR); Seongjun SIM, Suwon-si (KR)

(73) Assignee: SAMSUNG ELECTRONICS CO., LTD., Suwon-si (KR)

(21) Appl. No.: 19/406,295

(22) Filed: Dec. 2, 2025

Related U.S. Application Data
(63) Continuation of application No. PCT/KR2025/019321, filed on Nov. 20, 2025.

(30) Foreign Application Priority Data
Dec. 2, 2024 (KR) 10-2024-0176876

(51) Int. Cl. G06F 3/03; G06F 3/0482; G06F 3/14

(52) U.S. Cl. CPC G06F 3/0304; G06F 3/0482; G06F 3/1423

(57) ABSTRACT

An electronic device includes a communicator; an input/output interface to perform communication with a first display device and a second display device; and a processor executing instructions to cause the device to: control the communicator to receive first color data of a screen of the first display device from the external device; control the second display device to iteratively change screen setting information of the second display device; for each change in the screen setting information, control the communicator to receive a piece of second color data of a screen of the second display corresponding to a piece of screen setting information of a plurality of pieces of screen setting information; identify one of the plurality of screen setting information based on the first color data and the pieces of second color data; and set the screen of the second display device based on the identified piece of screen setting information.

### CROSS-REFERENCE TO RELATED APPLICATIONS

This application is a bypass continuation application of International Application No. PCT/KR2025/019321, filed on Nov. 20, 2025, which claims priority to Korean Patent Application No. 10-2024-0176876, filed on Dec. 2, 2024, in the Korean Intellectual Property Office, the disclosures of which are incorporated by reference herein in their entireties.

### BACKGROUND

### 1. Field

The disclosure relates to an electronic device connected to a plurality of display devices and capable of controlling the plurality of display devices and an operation method of the electronic device.

### 2. Description of Related Art

In modern computing environments, multiple displays, in particular, dual monitor setting, are widely used. Dual monitor environments contribute to increasing productivity in various tasks, such as multitasking, a graphic work, and data analysis, and have been adopted in various application fields, such as personal computers (PCs), workstations for professional tasks, and gaming environments.

However, in dual monitor environments in the related art, display devices operate independently, and image quality characteristics (e.g., a color temperature, a brightness, a contrast ratio, and a color gamut) of respective monitors of the display devices may be different from each other. This may cause problems such as color mismatch and differences in brightness and contrast ratio between dual monitors.

Related art image quality calibration techniques that are manually conducted are primarily used in single-monitor environments. Accordingly, manual execution of image quality calibration in a dual monitor environment is time-consuming and makes it difficult for general users without professional knowledge to set an optimal image quality. Thus, a method of automatically performing image quality calibration in a dual monitor environment is needed.

### SUMMARY

Additional aspects will be set forth in part in the description which follows and, in part, will be apparent from the description, or may be learned by practice of the presented embodiments.

According to an aspect of the disclosure, an electronic device including a communicator configured to communicate with an external device; an input/output interface configured to perform communication with a first display device and a second display device; memory storing one or more instructions; and at least one processor including processing circuitry. The one or more instructions, when executed by the at least one processor individually or collectively, may cause the electronic device to: control the communicator to receive first color data of a screen of the first display device from the external device; control the second display device to iteratively change screen setting information of the second display device through the input/output interface; for each change in the screen setting information of the second display device, control the communicator to receive a piece of second color data of a screen of the second display corresponding to a piece of screen setting information of a plurality of pieces of screen setting information of the second display device from the external device; identify a piece of screen setting information from among the plurality of screen setting information based on the first color data and the pieces of second color data; and control the second display device through the input/output interface so that the screen of the second display device is set based on the identified piece of screen setting information.

The first color data and the pieces of second color data may be obtained by a camera included in the external device.

The one or more instructions, when executed by the at least one processor individually or collectively, may further cause the electronic device to control the first display device and the second display device through the input/output interface to display same reference patterns.

The input/output interface may include a high-definition multimedia interface (HDMI) port or a display port (DP).

The one or more instructions, when executed by the at least one processor individually or collectively, may further cause the electronic device to: control the first display device through the input/output interface so that an object guiding a shooting area is displayed on the screen of the first display device; and based on the first color data being received, control the first display device through the input/output interface so that the display of the object is terminated or properties of the object are changed.

The identified piece of screen setting information may correspond to a piece of second color data, among the pieces of second color data, that is most similar to the first color data.

The first color data includes a first RGB data, and each piece of second color data includes a piece of second RGB data. The one or more instructions, when executed by the at least one processor individually or collectively, may cause the electronic device to: convert the first RGB data corresponding to the first color data into a first xyY data; and convert each piece of second RGB data corresponding to the pieces of second color data into a piece of second xyY data.

The first xyY data may include a first coordinate value expressed by a first x value and a first y value associated with a color space. Each piece of the second xyY data may include a second coordinate value expressed by a second x value and a second y value associated with the color space. The identified screen setting information may correspond to the second coordinate value that is closest to the first coordinate value.

The one or more instructions, when executed by the at least one processor individually or collectively, may further cause the electronic device to, based on the screen of the second display device being set based the identified piece of screen setting information, perform screen calibration so that the screen of the second display device and the screen of the first display device have substantially identical color or brightness.

A plurality of screens corresponding to the plurality of screen setting information may have different ranges of adjustable color coordinates.

The screen setting information of the second display device may be changed by changing information about at least one of a picture mode, a color temperature, or a color space included in a screen menu of the second display device.

According to an aspect of the disclosure, an operation method of an electronic device, the operation method may include receiving first color data of a screen of a first display device from an external device; controlling, through an input/output interface, a second display device to iteratively change screen setting information of a second display device; for each change in the screen setting information of the second display device, receiving a piece of second color data of a screen of the second display corresponding to a piece of screen setting information of a plurality of screen setting information of the second display device from the external device; identifying a piece of screen setting information from amongst the plurality of screen setting information based on the first color data and the pieces of second color data; and controlling the second display device through the input/output interface so that the screen of the second display device is set based on the identified piece of screen setting information.

The first color data and the pieces of second color data may be obtained by a camera included in the external device.

The operation method may further include controlling the first display device and the second display device to display same reference patterns.

The operation method may further include controlling the first display device through the input/output interface so that an object guiding a shooting area is displayed on the screen of the first display device; and based on the first color data being obtained, controlling the first display device through the input/output interface so that the display of the object is terminated or properties of the object are changed.

The identified piece of screen setting information may correspond to a piece of second color data, among the pieces of second color data, that is most similar to the first color data.

The first color data may include a first RGB data. Each piece of second color data may include a piece of second RGB data. The operation method may further include converting the first RGB data corresponding to the first color data into first xyY data; and converting each piece of second RGB data corresponding to the pieces of second color data into a piece of second xyY data.

The first xyY data may include a first coordinate value expressed by a first x value and a first y value associated with a color space. Each piece of the second xyY data may include a second coordinate value expressed by a second x values and a second y values associated with the color space, and the identified piece of screen setting information corresponds to the second coordinate value that is closest to the first coordinate value.

The operation method further includes based on the screen of the second display device being set based on the identified screen setting information, performing screen calibration so that the screen of the second display device and the screen of the first display device have substantially identical color or brightness.

According to an aspect of the disclosure, a non-transitory computer-readable recording medium having recorded thereon a program that is executed by at least one processor of an electronic device to perform the aforementioned operation method.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an electronic device, a plurality of display devices, and an external device according to an embodiment of the disclosure;

FIG. 2 is a graph showing a changeable range of color coordinates for each color temperature menu, according to an embodiment of the disclosure;

FIG. 3 is a flowchart of an operation method of an electronic device, according to an embodiment of the disclosure;

FIG. 4 is a diagram illustrating a method of obtaining color data of a screen of a first display device by using an external device according to an embodiment of the disclosure;

FIG. 5 is a diagram illustrating a method of obtaining color data of a screen of a second display device by using an external device according to an embodiment of the disclosure;

FIG. 6 is a graph showing first color data and pieces of second color data according to an embodiment of the disclosure in color coordinates;

FIG. 7 is a diagram illustrating a method, performed by an electronic device according to an embodiment of the disclosure, of setting a screen of a second display device;

FIG. 8 is a graph illustrating a method, performed by an electronic device according to an embodiment of the disclosure, of performing screen calibration of a second display device;

FIG. 9 is a block diagram of a structure of an electronic device according to an embodiment of the disclosure;

FIG. 10 is a block diagram of a structure of a display device according to an embodiment of the disclosure; and

FIG. 11 is a block diagram of a structure of a mobile device according to an embodiment of the disclosure.

### DETAILED DESCRIPTION

Terms used herein will be described briefly, and the disclosure will be described in detail.

Although general terms widely used at present were selected for describing the disclosure in consideration of the functions thereof, these general terms may vary according to intentions of one of ordinary skill in the art, case precedents, the advent of new technologies, or the like. Terms arbitrarily selected by the applicant of the disclosure may also be used in a specific case. In this case, their meanings need to be given in the detailed description of the disclosure. Hence, the terms must be defined based on their meanings and the contents of the entire specification, not by simply stating the terms.

The terms “comprises” and/or “comprising” or “includes” and/or “including” when used in this specification, specify the presence of stated elements, but do not preclude the presence or addition of one or more other elements. The terms “unit”, “. . . er (. . . or)”, and “module” when used in this specification refers to a unit in which at least one function or operation is performed, and may be implemented as hardware, software, or a combination of hardware and software.

The disclosure will now be described more fully with reference to the accompanying drawings, in which exemplary embodiments of the disclosure are shown. The disclosure may, however, be embodied in many different forms and should not be construed as being limited to the embodiments of the disclosure set forth herein. In the drawings, parts irrelevant to the description are omitted for the simplicity of explanation, and like numbers refer to like elements throughout.

The term “user” used herein denotes a person who controls a system, a function, or an operation. Examples of the user may include an inventor, a manager, or an installation engineer.

An ‘image’ or a ‘picture’ used in an embodiment of the disclosure may indicate a still image, a moving picture composed of a plurality of continuous still images (or frames), or a video.

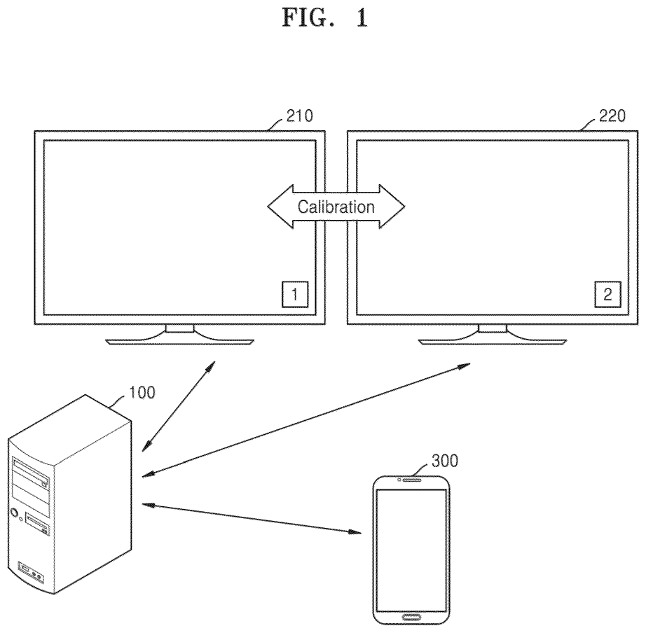

FIG. 1 is a diagram illustrating an electronic device, a plurality of display devices, and an external device according to an embodiment of the disclosure.

Referring to FIG. 1, an electronic device 100 according to an embodiment of the disclosure may be connected to the plurality of display devices via an input/output interface. For example, the plurality of display devices may include a first display device 210 and a second display device 220. However, embodiments are not limited thereto, and the electronic device 100 may be connected to more display devices than the two display devices.

The electronic device 100 according to an embodiment of the disclosure may be implemented in various forms, such as a desktop computer, a laptop computer, a tablet personal computer (PC), and a mobile phone. However, the disclosure is not limited thereto.

The electronic device 100 may be connected to the first display device 210 and the second display device 220 via a cable, and each of the electronic device 100 and the first display device 210 and the second display device 220 may include one or more ports for cable connection. The one or more ports may include a digital input interface, such as a high-definition multimedia interface (HDMI) port and a display port (DP). However, the disclosure is not limited thereto.

The electronic device 100 and the first display device 210 and second display device 220 may be connected to each other through display data channel/command interface (DDC/CI) communication via an HDMI port or a display port. The DDC communication may be a communication protocol that transmits functions and resolution information supported by the first display device 210 and the second display device 220 to the electronic device 100. The first display device 210 and second display device 220 may transmit extended display identification data (EDID) information of the first display device 210 and the second display device 220 to the electronic device 100 by using DDC communication.

The electronic device 100 may control settings of the first display device 210 or the second display device 220 by transmitting a command to the first display device 210 or the second display device 220 through the CI communication. For example, the electronic device 100 may change the settings of the first display device 210 or the second display device 220 by using software, without using an on-screen display (OSD) menu of the first display device 210 or the second display device 220. However, the disclosure is not limited thereto.

The first display device 210 and the second display device 220 according to an embodiment of the disclosure may include various types of electronic devices including displays. The first display device 210 and the second display device 220 may be implemented in various forms such as a TV, a monitor, a smart monitor, a mobile phone, a tablet PC, a digital camera, a camcorder, and a laptop computer. However, the disclosure is not limited thereto.

When the first display device 210 and the second display device 220 according to an embodiment of the disclosure are connected to the electronic device 100 and are used as dual monitors, there is a need to match the screen of the first display device 210 with the screen of the second display device 220 to have same color and brightness. Calibration may be performed to match the screen of the first display device 210 with the screen of the second display device 220 to have same color and brightness. In this case, the first display device 210 may be a reference display device, and the second display device 220 may be a target display device that undergoes calibration in order to match the screen of the reference display device. However, the disclosure is not limited thereto.

The electronic device 100 according to an embodiment of the disclosure may perform calibration to match the screen of the first display device 210 and the screen of the second display device 220 to the same color by using an external device 300 including a camera.

The electronic device 100 may perform communication with the external device 300, via wireless communication.

For example, the electronic device 100 and the external device 300 may include at least one communication module that performs communication according to a communication standard such as Bluetooth, Wi-Fi, Bluetooth low energy (BLE), near field communication/radio frequency identification (NFC/RFID), Wi-Fi direct, ultra-wideband (UWB), ZIGBEE, Internet, 3G, 4G, 5G, and/or 6G, and may be connected to each other via the communication modules. However, the disclosure is not limited thereto.

The external device 300 according to an embodiment of the disclosure may be implemented as any of various electronic devices, such as a mobile phone, a tablet PC, a digital camera, a camcorder, a laptop computer, and a wearable device. The external device 300 may be a mobile device including a camera. For example, the external device 300 may use the camera to photograph the screen of the first display device 210, and obtain color data (first color data) for the screen of the first display device 210. The external device 300 may also use the camera to photograph the screen of the second display device 220, and obtain color data (second color data) for the screen of the second display device 220.

The external device 300 may transmit the obtained first color data and the obtained second color data to the electronic device 100.

The electronic device 100 may adjust at least one parameter related to the screen of the second display device 220 so that the color and brightness of the screen of the first display device 210 and the color and brightness of the screen of the second display device 220 become identical to each other, based on the first color data and the second color data received from the external device 300.

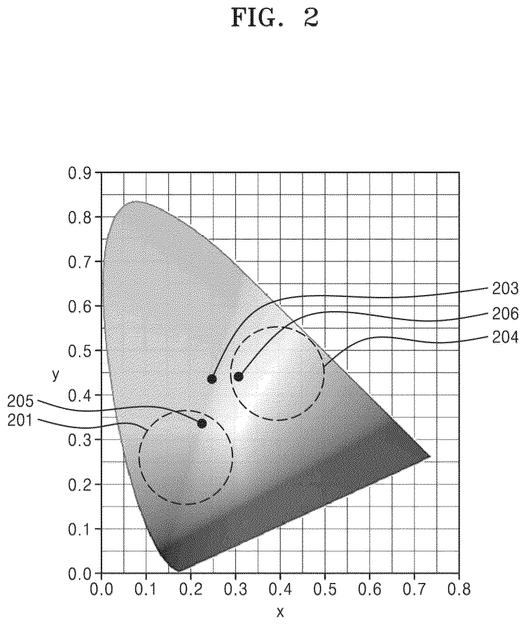

When the first display device 210 and the second display device 220 according to an embodiment of the disclosure are different from each other in terms of manufacturing company or model, different screen menus may be configured on the first display device 210 and the screen of the second display device 220. Ranges of adjusting color values may be different for the screen menus of the first display device 210 and the second display device 220. Accordingly, it may be difficult to adjust the color of the first display device and the color of the second display device to be identical to each other through only adjusting color values. This will now be described in greater detail with reference to FIG. 2.

FIG. 2 is a graph showing a changeable range of color coordinates for each color temperature menu, according to an embodiment of the disclosure.

A color temperature of a screen according to an embodiment of the disclosure is an index indicating the color of light appearing on the screen. The higher the color temperature of the screen, the cooler (bluer) tone the light coming out from the screen may appear, and the lower the color temperature, the warmer (reddish/yellow) tone the light coming out from the screen may appear. The display's screen setting menu may include a color temperature menu. For example, the color temperature menu may include a first mode (“Cool”), a second mode (“Standard”), a third mode (“Warm 1”), and a fourth mode (“Warm 2”). However, this is for convenience of explanation, and the color temperature menu may include fewer or more modes.

Referring to FIG. 2, when the color temperature menu is set to the first mode (“Cool”), color coordinate values may be changed within a first range 201. For example, when the color temperature menu is set to the first mode (“Cool”), a color value of the screen may be changed only within the first range 201.

When the color temperature menu is set to the fourth mode (“Warm 2”), color coordinate values may be changed within a second range 204. For example, when the color temperature menu is set to the fourth mode (“Warm 2”), a color value of the screen may be changed only within the second range 204.

Accordingly, when a color value of the screen of the first display device 210 is a first value 203 and the color temperature menu of the second display device 220 is set to the first mode (“Cool”), even when a color value of the second display device 220 is adjusted, a color value of the screen of the second display device 220 may not be calibrated to the first value 203. The color value of the second display device 220 may be calibrated to a second value 205 that is most similar to the first value 203 within the first range 201.

When the color value of the screen of the first display device 210 is the first value 203 and the color temperature menu of the second display device 220 is set to the fourth mode (“Warm 2”), even when the color value of the second display device 220 is adjusted, the color value of the screen of the second display device 220 may not be calibrated to the first value 203. The color value of the second display device 220 may be calibrated to a third value 206 that is most similar to the first value 203 within the second range 204. As such, when calibration is performed without optimizing the screen menu of the second display device 220, accurate calibration of the second display device 220 may not be performed.

Therefore, the electronic device 100 according to an embodiment of the disclosure may improve the efficiency and accuracy of calibration by optimizing the screen menu of the second display device 220 to the color data of the screen of the first display device 210 and then performing screen calibration of the second display device 220.

This will be described in greater detail with reference to the drawings below.

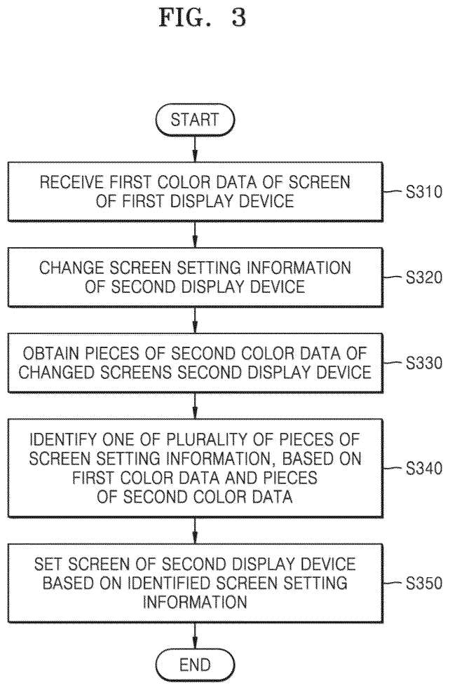

FIG. 3 is a flowchart of an operation method of an electronic device, according to an embodiment of the disclosure.

Referring to FIG. 3, the electronic device according to an embodiment of the disclosure may obtain first color data of a screen of a first display device (S310).

The first display device 210 according to an embodiment of the disclosure may be a reference display device. For example, a screen image displayed on the first display device 210 may be a screen image that serves as a reference for screen calibration.

The external device 300 may photograph the screen of the first display device 210 by using the camera included in the external device 300, and obtain first color data of the screen of the first display device 210. In this case, the first color data may include a RGB value.

The external device 300 may transmit the first color data to the electronic device 100. At this time, the first color data transmitted to the electronic device 100 may be raw data before image quality processing is performed in the camera.

The electronic device 100 according to an embodiment of the disclosure may change screen setting information of the second display device 220 (S320).

The second display device 220 according to an embodiment of the disclosure may be a target display device that undergoes screen calibration in order to match the screen of the reference display device to have same color.

The electronic device 100 and the second display device 220 according to an embodiment of the disclosure may be connected to each other through an input/output interface including an HDMI, a DP, or the like, and may transmit and receive data by using DDC/CI communication.

For example, the electronic device 100 may change at least one setting included in the screen menu of the second display device 220, by using DDC/CI communication. For example, the screen menu may include menus capable of changing a picture mode, brightness, a contrast ratio, a color temperature, a color space, etc. The picture mode menu is a menu provided to select an appropriate mode according to types of content or viewing environments, and each mode may include preset values allowing to quickly and easily adjust the image quality of a screen image. For example, the picture mode menu may include a standard mode, a dynamic mode, a movie mode, a sports mode, a game mode, a photo mode, an eco mode, a user mode, etc. However, embodiments are not limited thereto.

The brightness menu is a menu capable of adjusting the intensity of a backlight (e.g., a light source) coming out from the screen image, and may adjust the brightness and darkness of the screen image. The contrast menu may be a menu capable of adjusting a difference between brightness of brightest white and brightness of darkest black on the screen image. The color temperature menu may be a menu capable of adjusting the color temperature of the screen image, and the color space menu may be a menu capable of setting a coordinate system that defines the range of colors (color gamut) that may be expressed by the screen image. However, the disclosure is not limited thereto.

The electronic device 100 may change setting information for at least one of a picture mode, brightness, a contrast ratio, a color temperature, or a color space included in the screen menu of the second display device 220. As at least one setting information of the screen menu of the second display device 220 is changed, the color and brightness of the screen image displayed on the second display device 220 may be changed.

The electronic device 100 according to an embodiment of the disclosure may obtain pieces of second color data of changed screen images of the second display device 220 (S330).

For example, the external device 300 may photograph the screen image of the second display device 220 by using the camera included in the external device 300, every time screen setting information of the second display device 220 is changed. The external device 300 may obtain pieces of second color data of screen images of the second display device 220 corresponding to pieces of changed screen setting information. In this case, the pieces of second color data may include RGB values.

The external device 300 may transmit the pieces of second color data to the electronic device 100. In this case, the pieces of second color data transmitted to the electronic device 100 may be raw data before image quality processing is performed in the camera.

The electronic device 100 according to an embodiment of the disclosure may identify one of a plurality of pieces of screen setting information, based on the first color data and the pieces of second color data (S340).

The electronic device 100 may obtain first color coordinates corresponding to the first color data, by converting the first color data from a RGB value to a xyY value.

For example, the electronic device 100 may convert the first color data obtained in operation S310 from a RGB value to a xyY value. In detail, the electronic device 100 may normalize the RGB value and apply gamma inverse correction. The electronic device 100 may calculate X, Y, and Z values by using a conversion matrix on the RGB value to which gamma inverse correction has been applied. The electronic device 100 may calculate a first xyY value corresponding to a first RGB value by using a formula that converts X, Y, and Z values into a xyY value. An x value and a y value included in the first xyY value may represent the first color coordinates, and the Y value may represent a brightness value.

The electronic device 100 may also obtain second color coordinates corresponding to the pieces of second color data obtained in operation S330, by converting the pieces of second color data from a RGB value to a xyY value.

In this case, each of the pieces of second color data may correspond to each of the pieces of changed screen setting information. For example, color data obtained by photographing the screen of the second display device 220 when the screen of the second display device 220 is set based on first screen setting information may be referred to as 2-1 color data. For example, color data obtained by photographing the screen of the second display device 220 after the screen of the second display device 220 is changed from the first screen setting information to second screen setting information may be referred to as 2-2 color data. However, the disclosure is not limited thereto.

The electronic device 100 may obtain second color coordinates corresponding to a plurality of pieces of screen information, by converting the pieces of second color data including the 2-1 color data and the 2-2 color data from a RGB value to a xyY value. For example, the second color coordinates may include 2-1 color coordinates corresponding to the first screen setting information and 2-2 color coordinates corresponding to the second screen setting information.

The electronic device 100 may identify second color coordinates that are closest to the first color coordinates from among the second color coordinates. For example, in a color coordinate system, the electronic device 100 may identify second color coordinates corresponding to a second point closest to a first point represented by the first color coordinates from among second points represented by the second color coordinates.

The electronic device 100 may also identify screen setting information corresponding to the identified second color coordinates. For example, when the identified color coordinates are the 2 -2 color coordinates, the electronic device 100 may identify second screen setting information corresponding to the 2-2 color coordinates.

The electronic device 100 may set the screen of the second display device 220, based on identified screen information (S350).

For example, the electronic device 100 may set the screen of the second display device 220, based on the identified second screen setting information, by using DDC/CI communication.

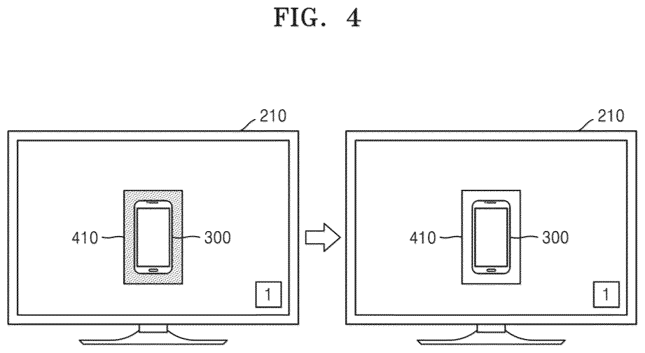

FIG. 4 is a diagram illustrating a method of obtaining color data of a screen of a first display device by using an external device according to an embodiment of the disclosure.

The electronic device 100 according to an embodiment of the disclosure may be connected to the first display device 210 through an input/output interface, and may perform DDC/CI communication.

A program (application) for performing screen calibration may be pre-provided in the electronic device 100 according to an embodiment of the disclosure. For example, the electronic device 100 may control the first display device 210 to display an icon representing a program for performing screen calibration. When receiving a user input of selecting an icon, the electronic device 100 may execute a program for screen calibration.

When the program for screen calibration is executed, the electronic device 100 may set a reference display device and a target display device, based on the user input.

For example, referring to FIG. 4, when the first display device 210 is set as a reference display device, a number ‘1’ may be displayed on the screen of the first display device 210. However, the disclosure is not limited thereto, and, according to various methods, the first display device 210 may be displayed as being a reference display device.

The electronic device 100 may transmit reference pattern information to the first display device 210 via DDC/CI communication. The first display device 210 may display a reference pattern, based on the reference pattern information received from the electronic device 100. In this case, the reference pattern may be a white pattern. However, the disclosure is not limited thereto.

The electronic device 100 according to an embodiment of the disclosure may control the first display device 210 to display an object guiding a shooting area on the screen of the first display device 210. For example, the electronic device 100 may control the first display device 210 to display a guide box 410 having a first color on the screen of the first display device 210, via DDC/CI communication. However, the disclosure is not limited thereto.

A program for screen calibration may be pre-provided also in the external device 300 according to an embodiment of the disclosure. The program for screen calibration provided in the external device 30 may be executed based on the user input. When the program for screen calibration is executed, the external device 300 may establish communication with the electronic device 100, based on the user input, and may photograph the screens of the first display device 210 and the second display device 220.

As illustrated in FIG. 4, when the external device 300 is positioned in the guide box 410 displayed on the screen of the first display device 210, the screen of the first display device 210 may be automatically photographed by the camera of the external device 300. Alternatively, the external device 300 may photograph the screen of the first display device 210, based on the user input. However, the disclosure is not limited thereto.

The external device 300 may obtain the first color data by photographing the screen of the first display device 210. The external device 300 may transmit the first color data to the electronic device 100. In this case, the first color data transmitted to the electronic device 100 may include a RGB value, and may be raw data before image quality processing is performed in the camera.

When the screen photographing of the first display device 210 by the external device 300 is terminated and the first color data is obtained, the electronic device 100 may change attributes of the object guiding the shooting area displayed on the screen of the first display device 210. For example, the electronic device 100 may control the first display device 210 to change the color of the guide box 410 displayed on the screen of the first display device 210 from the first color to the second color and display the guide box 410 with the second color.

Accordingly, a user may easily recognize that a process of obtaining the first color data for the screen of the first display device 210 is completed.

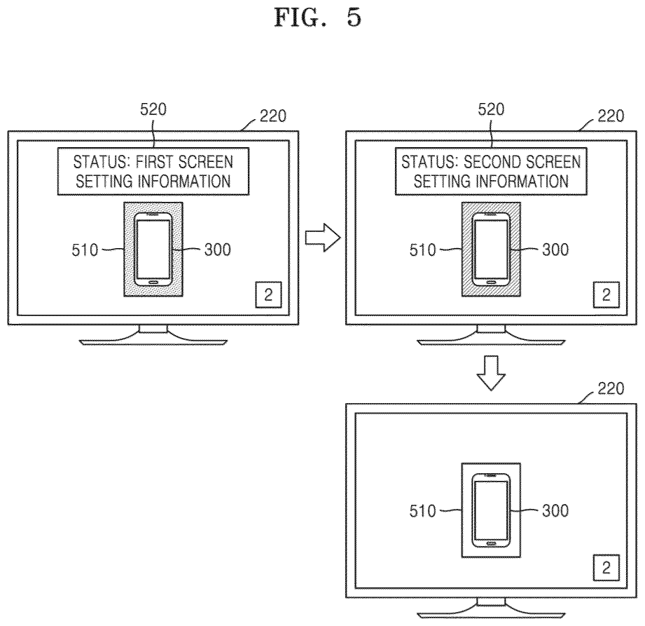

FIG. 5 is a diagram illustrating a method of obtaining color data of a screen of a second display device by using an external device according to an embodiment of the disclosure.

The electronic device 100 according to an embodiment may be connected to the second display device 220 through an input/output interface, and may perform DDC/CI communication.

The second display device 220 may be a target display device that undergoes screen calibration in order to match the screen of a reference display device to have same color and brightness.

When the second display device 200 is set as a target display device, a number ‘2’ may be displayed on the screen of the second display device 220. However, the disclosure is not limited thereto, and, according to various methods, the second display device 220 being a target display device may be displayed.

The electronic device 100 may transmit pattern information that is the same as the reference pattern transmitted to the first display device 210, to the second display device 220 via DDC/CI communication. The second display device 220 may display a reference pattern, based on the reference pattern information received from the electronic device 100. In this case, the reference pattern may be a white pattern. However, the disclosure is not limited thereto.

The electronic device 100 according to an embodiment of the disclosure may control the second display device 220 to display an object guiding a shooting area on the screen of the second display device 220. For example, the electronic device 100 may control the second display device 220 to display a guide box 510 having a first color on the screen of the second display device 220, via DDC/CI communication. However, the disclosure is not limited thereto.

As illustrated in FIG. 5, when the external device 300 is positioned in the guide box 510 displayed on the screen of the second display device 220, the screen of the second display device 220 may be automatically photographed by the camera of the external device 300. Alternatively, the external device 300 may photograph the screen of the second display device 220, based on the user input. However, the disclosure is not limited thereto.

The electronic device 100 according to an embodiment of the disclosure may change screen setting information of the second display device 220 while the screen of the second display device 220 is being photographed by the external device 300.

According to an embodiment of the disclosure, the second display device 220 may include a screen menu for setting information about the screen. The screen menu may include menus capable of changing a picture mode, brightness, a contrast, a color temperature, a color space, etc.

For example, the electronic device 100 may control the second display device 220 to change settings of the color temperature menu included in the screen menu of the second display device 220. The color temperature of the second display device 220 may be set to any one of first, second, third, and fourth modes (e.g., cool, standard, warm 1, and warm 2). The electronic device 100 may control the second display device 220 to set the color temperature of the second display device 220 to the first mode (cool).

The external device 300 may obtain 2-1 color data corresponding to the first mode (cool), by photographing the screen of the second display device 220 having the color temperature set to the first mode (cool). The external device 300 may transmit the 2-1 color data to the electronic device 100. In this case, the 2-1 color data transmitted to the electronic device 100 may include a RGB value, and may be raw data before image quality processing is performed in the camera.

The electronic device 100 may control the second display device 220 to display information 520 about a current screen setting status or a currently-being-changed screen menu of the second display device 220.

The electronic device 100 may also control the second display device 220 to set the color temperature of the second display device 220 to the second mode (standard). When the screen setting information of the second display device 220 is changed, the electronic device 100 may control the second display device 220 to change the color of the guide box 510 and display the guide box 510 having the changed color. For example, when the color temperature of the screen of the second display device 220 changes from the first mode to the second mode, the guide box 510 may be changed from the first color to a third color.

The external device 300 may obtain 2 -2 color data corresponding to the second mode (standard), by photographing the screen of the second display device 220 having the color temperature set to the second mode (standard). The external device 300 may transmit the 2 -2 color data to the electronic device 100. In this case, the 2-2 color data transmitted to the electronic device 100 may include a RGB value, and may be raw data before image quality processing is performed in the camera.

The electronic device 100 may also control the second display device 220 to set the color temperature of the second display device 220 as the third mode (warm 1). When the color temperature of the screen of the second display device 220 changes from the first mode to the third mode, the guide box 510 may be changed from the third color to a fourth color.

The external device 300 may obtain 2-3 color data corresponding to the third mode (warm 1), by photographing the screen of the second display device 220 having the color temperature set to the third mode (warm 1). The external device 300 may transmit the 2-3 color data to the electronic device 100. In this case, the 2-3 color data may include a RGB value, and may be raw data before image quality processing is performed in the camera.

The electronic device 100 may also control the second display device 220 to set the color temperature of the second display device 220 as the fourth mode (warm 2). When the color temperature of the screen of the second display device 220 changes from the third mode to the fourth mode, the guide box 510 may be changed from the fourth color to a fifth color.

The external device 300 may obtain 2-4 color data corresponding to the fourth mode (warm 2), by photographing the screen of the second display device 220 having the color temperature set to the fourth mode (warm 2). The external device 300 may transmit the 2-4 color data to the electronic device 100. In this case, the 2-4 color data may include a RGB value, and may be raw data before image quality processing is performed in the camera.

In all modes for the color temperature, when screen shooting of the second display device 220 by the external device 300 is terminated, the electronic device 100 may control the second display device 220 to change the color of the guide box 510 to the second color and display the guide box 510 having the second color.

Accordingly, a user may easily recognize that a process of obtaining the pieces of second color data for the screen of the second display device 220 is completed.

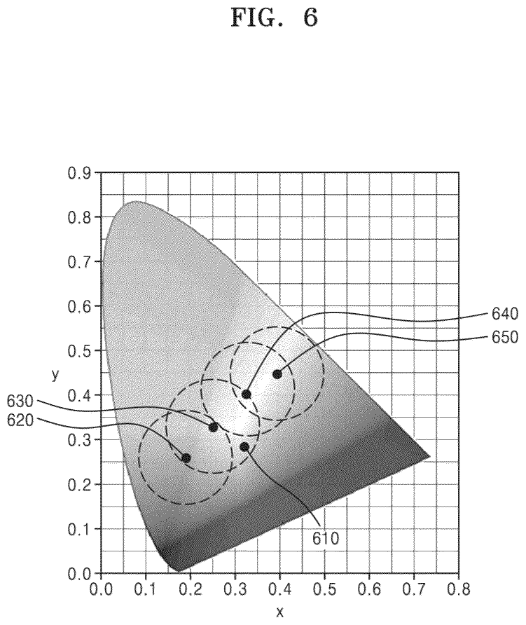

FIG. 6 is a graph showing first color data and pieces of second color data according to an embodiment of the disclosure in color coordinates.

The electronic device 100 according to an embodiment of the disclosure may receive the first color data obtained by photographing the screen of the first display device 210 from the external device 300.

The electronic device 100 may convert the first color data from a RGB value to a xyY value. For example, the electronic device 100 may perform normalization and gamma inverse correction on a first RGB value (first color data) received from the external device 300, and may calculate X, Y, and Z values corresponding to the first RGB value by using a transformation matrix. The electronic device 100 may calculate a first xyY value corresponding to the first RGB value by using a formula that converts the X, Y, and Z values into the xyY value. An x value and a y value included in the first xyY value may represent color coordinates, and the Y value may represent a brightness value.

For example, the x value (a first x value) and the y value (a first y value) included in the first xyY value may represent a first point 610 in the color coordinates of FIG. 6.

The electronic device 100 may receive pieces of second color data obtained by photographing screens having different screen setting information of the second display device 220. For example, the screens may have different color temperature settings. However, the disclosure is not limited thereto.

The electronic device 100 may receive, from the external device 300, 2-1 color data corresponding to a screen whose color temperature is set to the first mode (Cool).

The electronic device 100 may convert the 2-1 color data from a RGB value to a xyY value. The electronic device 100 may convert a second RGB value (2-1 color data) received from the external device 300 into a second xyY value. For example, a second x value and a second y value included in the second xyY value may represent a second point 620 in the color coordinates of FIG. 6.

The electronic device 100 may receive, from the external device 300, 2-1 color data corresponding to a screen whose color temperature is set to the second mode (Standard).

The electronic device 100 may convert the 2 -2 color data from a RGB value to a xyY value. The electronic device 100 may convert a third RGB value (2-2 color data) received from the external device 300 into a third xyY value. For example, a third x value and a third y value included in the third xyY value may represent a third point 630 in the color coordinates of FIG. 6.

The electronic device 100 may receive, from the external device 300, 2-3 color data corresponding to a screen whose color temperature is set to the third mode (Warm 1).

The electronic device 100 may convert the 2-3 color data from a RGB value to a xyY value. The electronic device 100 may convert a fourth RGB value (2-3 color data) received from the external device 300 into a fourth xyY value. For example, a fourth x value and a fourth y value included in the fourth xyY value may represent a fourth point 640 in the color coordinates of FIG. 6.

The electronic device 100 may receive, from the external device 300, 2-4 color data corresponding to a screen whose color temperature is set to the fourth mode (Warm 2).

The electronic device 100 may convert the 2-4 color data from a RGB value to a xyY value. The electronic device 100 may convert a fifth RGB value (2-4 color data) received from the external device 300 into a fifth xyY value. For example, a fifth x value and a fifth y value included in the fifth xyY value may represent a fifth point 650 in the color coordinates of FIG. 6.

The electronic device 100 according to an embodiment may identify screen setting information, based on second color data that is most similar to the first color data from among the pieces of second color data.

For example, the electronic device 100 may identify the 2 -2 color data corresponding to the third point 630 closest to the first point 610 corresponding to the first color data. The electronic device 100 may identify screen setting information corresponding to the 2-2 color data (e.g., indicating that the color temperature is set to the second mode (Standard)).

The electronic device 100 may control the second display device 220 to set the screen of the second display device 220, based on the identified screen setting information.

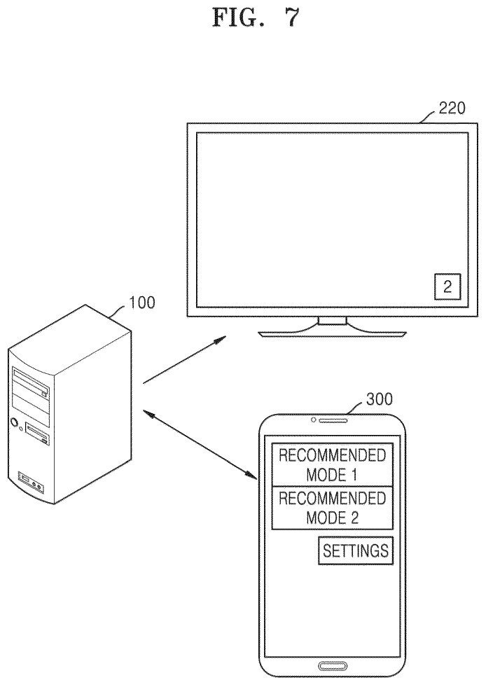

Alternatively, the electronic device 100 may set the screen of the second display device 220, based on the identified second screen setting information, in response to a user input. This will be described in greater detail later with reference to FIG. 7.

FIG. 7 is a diagram illustrating a method, performed by an electronic device according to an embodiment of the disclosure, of setting a screen of a second display device, in response to a user input.

Referring to FIG. 7, the electronic device 100 according to an embodiment of the disclosure may identify the second color data that is most similar to the first color data from among the pieces of second color data. The electronic device 100 may identify screen setting information corresponding to the identified second color data among a plurality of screen setting information of the second display device 220 corresponding to the pieces of second color data.

The electronic device 100 may determine one or more recommended modes (e.g., recommended mode 1 and recommended mode 2) of the screen of the second display device 220, based on the identified screen setting information. The electronic device 100 may transmit the identified screen setting information or information about the one or more recommended modes to the external device 300, by using wireless communication. The external device 300 may display a message asking whether to set the screen based on the identified screen setting information or a user input interface screen image capable of selecting one of the one or more recommended modes.

Alternatively, the electronic device 100 may control the second display device 220 to display a message asking whether to set the screen of the second display device 220 based on the identified screen setting information or a screen image capable of selecting one of the one or more recommended modes.

When receiving, from the external device 300 or the second display device 220, a user input of setting the screen of the second display device 220 to the identified screen setting information or to a recommended mode selected by the user, the electronic device 100 may set the screen of the second display device 220, based on the identified screen setting information or screen setting information corresponding to the recommended mode selected by the user. For example, the electronic device 100 may control the color temperature of the screen of the second display device 220 to be set to the second mode (standard) corresponding to the second color data or to be set to another recommended mode based on the second mode.

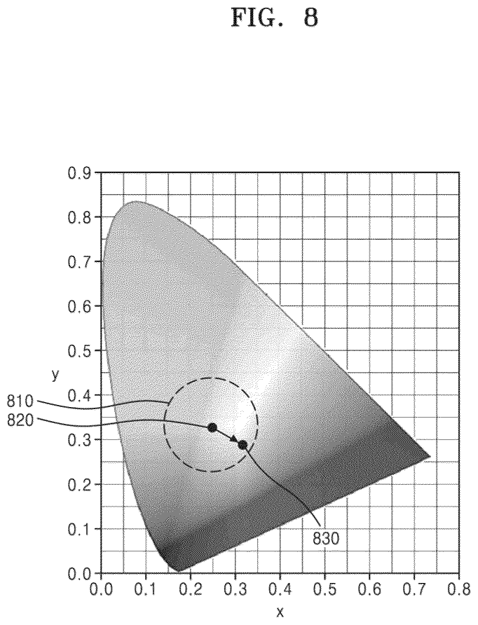

FIG. 8 is a graph illustrating a method, performed by an electronic device according to an embodiment of the disclosure, of performing screen calibration of a second display device.

Referring to FIG. 8, the electronic device 100 according to an embodiment of the disclosure may control the screen of the second display device 220 to be set based on the identified screen setting information, through DDC/CI communication.

For example, the electronic device 100 may set the color temperature of the screen of the second display device 220 to the second mode (Standard).

The electronic device 100 may perform screen calibration of the second display device 220, while the color temperature of the screen of the second display device 220 is set to the second mode (Standard).

When the color temperature of the screen of the second display device 220 is set to the second mode (Standard), a color value of the screen of the second display device 220 may be adjusted within a second range 810.

The electronic device 100 may adjust screen-related parameters of the second display device 220 so that the brightness and color of the screen of the second display device 220 whose color temperature is set to the second mode (Standard) become identical to the brightness and color of the screen of the first display device 210.

For example, the electronic device 100 may control the brightness and color of the screen of the second display device 220 to be the same as the brightness and color of the screen of the first display device 210, by adjusting at least one of a brightness, a contrast ratio, a white balance, a RGB balance, a gamma value, a color gamut, or a gray scale.

Accordingly, a color value 820 of the second display device 220 may be calibrated in a direction to become identical to a color value 830 of the first display device 210.

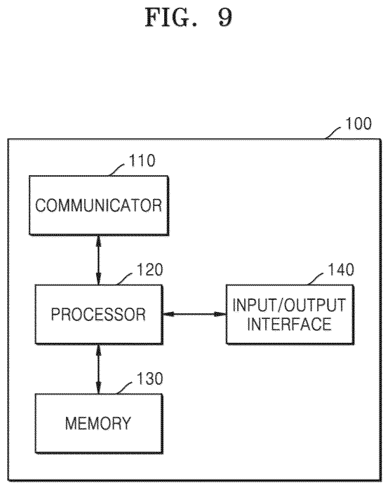

FIG. 9 is a block diagram of a structure of an electronic device according to an embodiment of the disclosure.

Referring to FIG. 9, the electronic device 100 according to an embodiment of the disclosure of the disclosure may include a communicator 110, at least one processor 120, memory 130, and an input/output interface 140.

According to an embodiment of the disclosure, the communicator 110 may perform a communication connection between the electronic device 100 and an external device (e.g., the external device 300) to receive or transmit a command or data. For example, the communicator 110 may include at least one wireless communication module, a wireless communication circuit, or a wireless communication device that performs wireless communication with the external device. For example, the communicator 110 may include a Wi-Fi module, a Bluetooth module, an infrared communication module, a wireless communication module, a LAN module, an Ethernet module, and the like. Each of these communication modules may be implemented in the form of at least one hardware chip.

The Wi-Fi module and the Bluetooth module may perform communication according to a Wi-Fi method and a Bluetooth method, respectively. When using a Wi-Fi module or a Bluetooth module, the communication interface 350 may first transmit or receive various types of connection information, such as a service set ID (SSID) and a session key, connect with various external devices by using the various types of connection information, and then transmit or receive various pieces of information. The wireless communication module may include at least one communication chip that performs communication according to various wireless communication standards, such as Zigbee, 3^{rd} Generation (3G), 3^{rd} Generation Partnership Project (3GPP), Long Term Evolution (LTE), LTE Advanced (LTE-A), 4^{th} Generation (4G), and 5^{th} Generation (5G). However, the disclosure is not limited thereto, and a configuration and operation of the communicator 110 may be implemented in various ways according to embodiments of the disclosure.

The communicator 110 according to an embodiment of the disclosure may receive, from the external device 300, the first color data and the pieces of second color data obtained by photographing the screens of the first display device 210 and the second display device 220.

The processor 120 according to an embodiment of the disclosure may control overall operations of the electronic device 100. The processor 120 may execute one or more programs stored in the memory 130. The memory 130 according to an embodiment of the disclosure may store various pieces of data, programs, or applications for driving and controlling the electronic device 100.

The processor 120 controls an overall operation of the electronic device 100 and signal transfer among the internal components of the electronic device 100 and processes data. When there is an input of a user or stored preset conditions are satisfied, the processor 120 may execute an operating system (OS) and various applications that are stored in the memory 130.

The processor 120 may include random-access memory (RAM) that stores a signal or data input by an external source of the electronic device 100 or is used as a memory area for various operations performed by the electronic device 100, read-only memory (ROM) that stores a control program for controlling the electronic device 100, and a processor.

The processor 120 may include a single core, a dual core, a triple core, a quad core, or a multiple core thereof. The processor 120 may include a plurality of processors. For example, the processor 120 may be implemented by using a main processor and a sub-processor.

The processor 120 may include at least one of a central processing unit (CPU), a graphics processing unit (GPU), or a video processing unit (VPU). Alternatively, according to embodiments of the disclosure, the processor 120 may be implemented in the form of a system on chip (SOC) that integrates at least one of a CPU, a GPU, or a VPU. Alternatively, the processor 120 may further include a neural processing unit (NPU).

The memory 130 according to an embodiment of the disclosure may store various pieces of data, programs, or applications for driving and controlling the electronic device 100.

A program stored in the memory 130 may include one or more instructions. The program (one or more instructions) or application stored in the memory 130 may be executed by the processor 120.

The processor 120 according to an embodiment of the disclosure may execute the one or more instructions stored in the memory 130 to thereby obtain the first color data of the screen of the first display device 210. For example, the processor 120 may control the communicator 110 to receive, from the external device 300, the first color data of the screen of the first display device 210 photographed using the camera included in the external device 300.

The processor 120 according to an embodiment of the disclosure may execute the one or more programs stored in the memory 130 to thereby change the screen setting information of the second display device 220. For example, the processor 120 may control the input/output interface 140 so that at least one setting of the screen menu of the second display device 220 is changed.

The processor 120 according to an embodiment of the disclosure may execute the one or more programs stored in the memory 130 to thereby obtain the pieces of second color data of the changed screens of the second display device 220. For example, the processor 120 may control the communicator 110 to receive, from the external device 300, the pieces of second color data of the changed screens of the second display device 220 photographed using the camera included in the external device 300.

The processor 120 according to an embodiment of the disclosure may identify one of a plurality of screen setting information, based on the first color data and the pieces of second color data, by executing the one or more programs stored in the memory 130. For example, the processor 120 may obtain first color coordinates corresponding to the first color data, by converting the first color data including a RGB value into a xyY value. The processor 120 may also obtain second color coordinates corresponding to the pieces of second color data, by converting the pieces of second color data including a RGB value into a xyY value. The processor 120 may identify second color coordinates that are closest to the first color coordinates from among the second color coordinates, and may identify screen setting information corresponding to the identified second color coordinates.

The processor 120 according to an embodiment of the disclosure may execute the one or more programs stored in the memory 130 to thereby control the input/output interface 140 so that the screen of the second display device 220 is set based on the identified screen setting information. For example, when the identified screen setting information indicates that the color temperature is a “standard mode”, the processor 120 may control the input/output interface 140 to set the color temperature of the screen of the second display device 220 to the “standard mode”.

The input/output interface 140 according to an embodiment of the disclosure may include at least one port for connection to the external device through a wired cable in order to communicate with the external device by wire. For example, the input/output interface 140 may include at least one of a HDMI, an MHL, a USB, a DP, a Thunderbolt port, a VGA port, a RGB port, a D-SUB, a DVI, a component jack, or a PC port. The input/output interface 140 may perform communication with the external device connected by wire through the at least one port.

The input/output interface 140 according to an embodiment of the disclosure may be connected to the first display device 210 and second display device 220 through DDC/CI communication. For example, the input/output interface 140 may receive EDID information of the first display device 210 and second display device 220 from the first display device 210 and second display device 220. The input/output interface 140 may transmit, to the first display device 210 or the second display device 220, commands for changing settings of the first display device 210 or the second display device 220. However, the disclosure is not limited thereto.

The block diagram of the electronic device 100 shown in FIG. 9 is only an embodiment. Components illustrated in FIG. 9 may be combined or omitted according to the specifications of the electronic device 100 when being actually implemented, or additional components may be included in the block diagram of FIG. 9. In other words, two or more components may be combined into a single component, or a single component may be divided into two or more components. A function performed in each block is merely an example to explain embodiments, and a detailed operation or device of each block does not limit the scope of the embodiments.

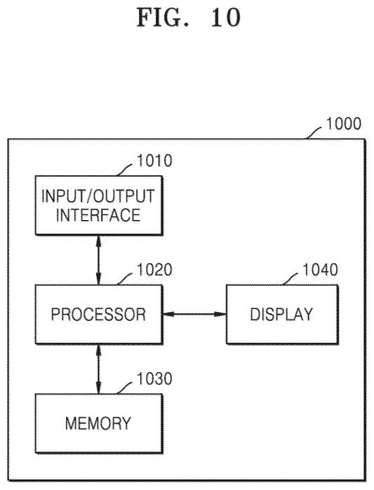

FIG. 10 is a block diagram of a structure of a display device 1000 according to an embodiment of the disclosure.

The display device 1000 of FIG. 10 may be an embodiment of the first display device 210 or the second display device 220.

Referring to FIG. 10, the display device 1000 according to an embodiment of the disclosure may include an input/output interface 1010, at least one processor 1020, memory 1030, and a display 1040.

The input/output interface 1010 according to an embodiment of the disclosure may include at least one port for connection to an external device through a wired cable in order to communicate with the external device by wire. For example, the input/output interface 1010 may include at least one of a HDMI, an MHL, a USB, a DP, a Thunderbolt port, a VGA port, a RGB port, a D-SUB, a DVI, a component jack, or a PC port. The input/output interface 140 may perform communication with the external device connected by wire through the at least one port.

The input/output interface 1010 according to an embodiment of the disclosure may be connected to the electronic device 100 through DDC/CI communication. For example, the input/output interface 1010 may transmit EDID information to the electronic device 100. The input/output interface 1010 may receive commands for changing the settings of the display device 1000 from the electronic device 100. However, the disclosure is not limited thereto.

The processor 120 according to an embodiment of the disclosure may control overall operations of the display device 1000. The processor 1020 may execute one or more programs stored in the memory 1030. The memory 1030 according to an embodiment of the disclosure may store various pieces of data, programs, or applications for driving and controlling the display device 1000.

The processor 1020 controls an overall operation of the display device 1000 and signal transfer among the internal components of the display device 1000, and processes data. When there is an input of a user or stored preset conditions are satisfied, the processor 1020 may execute an operating system (OS) and various applications that are stored in the memory 1030.

The processor 1020 according to an embodiment of the disclosure may control an operation of the display device 1000, based on control commands received from the electronic device 100. For example, the processor 1020 may control the display 1040 to display a reference pattern, based on the reference pattern information received from the electronic device 100. The processor 1020 may change screen setting information, based on a control command received from the electronic device 100, and may control the display 1040 to display changed screens. However, the disclosure is not limited thereto.

The display 1040 according to an embodiment of the disclosure generates a driving signal by converting an image signal, a data signal, an OSD signal, and a control signal that are processed by the processor 1020. The display 1040 may be a plasma display panel (PDP), a liquid-crystal display (LCD), an organic light-emitting device (OLED), a flexible display, or a 3-dimensional (3D) display. The display 1040 may be configured as a touch screen, and thus may serve as an input device as well as an output device.

The display 1040 according to an embodiment of the disclosure may display, for example, a reference pattern screen, an object guiding screen shooting, screens changed according to screen setting information, information indicating the status of a current screen. However, the disclosure is not limited thereto.

The block diagram of the display device 1000 shown in FIG. 10 is only an embodiment. Components illustrated in FIG. 10 may be combined or omitted according to the specifications of the display device 1000 when being actually implemented, or additional components may be included in the block diagrams of FIG. 10. In other words, two or more components may be combined into a single component, or a single component may be divided into two or more components. A function performed in each block is merely an example to explain embodiments, and a detailed operation or device of each block does not limit the scope of the embodiments.

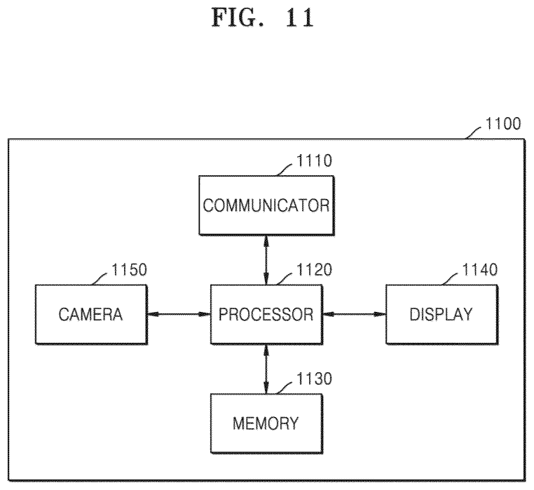

FIG. 11 is a block diagram of a structure of a mobile device 1100 according to an embodiment of the disclosure.

The mobile device 1100 of FIG. 11 may be an embodiment of the external device 300.

The mobile device 1100 according to an embodiment of the disclosure may include a communicator 1110, at least one processor 1120, memory 1130, a display 1140, and a camera 1150.

The communicator 1110 according to an embodiment of the disclosure may transmit or receive data or a signal to or from an external device (for example, the electronic device 100).

The communicator 1110 according to an embodiment of the disclosure may include a Wi-Fi module, a Bluetooth module, an infrared communication module, a wireless communication module, and the like. Each of these communication modules may be implemented in the form of at least one hardware chip.

The Wi-Fi module and the Bluetooth module may perform communication according to a Wi-Fi method and a Bluetooth method, respectively. When using a Wi-Fi module or a Bluetooth module, the communicator 1110 may first transmit or receive various types of connection information, such as a service set ID (SSID) and a session key, connect with various external devices by using the various types of connection information, and then transmit or receive various pieces of information. The wireless communication module may include at least one communication chip that performs communication according to various wireless communication standards, such as Zigbee, 3^{rd} Generation (3G), 3^{rd} Generation Partnership Project (3GPP), Long Term Evolution (LTE), LTE Advanced (LTE-A), 4^{th} Generation (4G), and 5^{th} Generation (5G).

The communicator 110 according to an embodiment of the disclosure may transmit, to the electronic device 100, the first color data obtained by photographing the screen of the first display device 210 and the pieces of second color data obtained by photographing the screen of the second display device 220.

The processor 1120 according to an embodiment of the disclosure controls an overall operation of the mobile device 1100, controls signal transfer among the internal components of the mobile device 1100, and processes data.

The processor 1120 may include a single core, a dual core, a triple core, a quad core, or a multiple core thereof. The processor 1120 may include a plurality of processors. For example, the processor 1120 may be implemented by using a main processor and a sub-processor.

The processor 1120 may include at least one of a central processing unit (CPU), a graphics processing unit (GPU), or a video processing unit (VPU). Alternatively, according to embodiments of the disclosure, the processor 1120 may be implemented in the form of a system on chip (SOC) that integrates at least one of a CPU, a GPU, or a VPU. Alternatively, the processor 1120 may further include a neural processing unit (NPU).

The memory 1130 according to an embodiment of the disclosure may store various pieces of data, programs, or applications for driving and controlling the mobile device 1100.

A program stored in the memory 1130 may include one or more instructions. The program (one or more instructions) or application stored in the memory 1130 may be executed by the processor 1120.

The camera 1150 according to an embodiment of the disclosure may obtain an image frame, such as an image or a video. For example, the camera 1150 may capture an image of the outside of the mobile device 1100. The image captured via the camera 1150 may be processed by the processor 1120 or a separate image processor.

For example, the camera 1150 may photograph a screen image displayed on the first display device 210 and screens displayed on the second display device 220. The camera 1150 may transmit pieces of color data corresponding to the photographed screen images (for example, the first color data and the pieces of second color data) to the electronic device 100. The pieces of color data transmitted to the electronic device 100 may be raw data not yet processed by the processor 1120 or a separate image processor.

The display 1140 according to an embodiment of the disclosure generates a driving signal by converting an image signal, a data signal, an OSD signal, and a control signal that are processed by the processor 1120. The display 1140 may be a PDP, an LCD, an OLED, a flexible display, or a 3D display. The display 1140 may be configured as a touch screen, and thus may serve as an input device as well as an output device.

The display 1140 according to an embodiment of the disclosure may display, for example, a user interface for performing screen calibration. However, the disclosure is not limited thereto.

The block diagram of the mobile device 1100 shown in FIG. 11 is only an embodiment. Components illustrated in FIG. 11 may be combined or omitted according to the specifications of the mobile device 1100 when being actually implemented, or additional components may be included in the block diagram of FIG. 11. In other words, two or more components may be combined into a single component, or a single component may be divided into two or more components. A function performed in each block is merely an example to explain embodiments, and a detailed operation or device of each block does not limit the scope of the embodiments of the disclosure.

An electronic device according to an embodiment of the disclosure may include a communicator configured to communicate with an external device, an input/output interface configured to perform communication with a first display device and a second display device, memory storing one or more instructions, and at least one processor including processing circuitry.

The one or more instructions, when executed by the at least one processor individually or collectively, may cause the electronic device to control the communicator to receive first color data of a screen of the first display device from the external device.

The one or more instructions, when executed by the at least one processor individually or collectively, may cause the electronic device to control the second display device to change screen setting information of the second display device, through the input/output interface.

The one or more instructions, when executed by the at least one processor individually or collectively, may cause the electronic device to, based on a change in the screen setting information of the second display device, control the communicator to receive pieces of second color data of screens corresponding to a plurality of screen setting information of the second display device from the external device.

The one or more instructions, when executed by the at least one processor individually or collectively, may cause the electronic device to identify one of the plurality of screen setting information, based on the first color data and the pieces of second color data.

The one or more instructions, when executed by the at least one processor individually or collectively, may cause the electronic device to control the second display device through the input/output interface so that the screen of the second display device is set based on the identified screen setting information.

The first color data and the pieces of second color data may be obtained by a camera included in the external device.

The one or more instructions, when executed by the at least one processor individually or collectively, may cause the electronic device to, through the input/output interface, control the first display device and the second display device to display the same reference patterns.

The input/output interface may include a high-definition multimedia interface (HDMI) port or a display port (DP).

The one or more instructions, when executed by the at least one processor individually or collectively, may cause the electronic device to control the first display device through the input/output interface so that an object guiding a shooting area is displayed on the screen of the first display device.

The one or more instructions, when executed by the at least one processor individually or collectively, may cause the electronic device to, based on the first color data being obtained, control the first display device through the input/output interface so that the display of the object is terminated or properties of the object are changed.

The one or more instructions, when executed by the at least one processor individually or collectively, may cause the electronic device to identify screen setting information corresponding to second color data that is most similar to the first color data from among the pieces of second color data.

The first color data and the pieces of second color data may include RGB data or xyY data.

The one or more instructions, when executed by the at least one processor individually or collectively, may cause the electronic device to convert first RGB data corresponding to the first color data into first xyY data.

The one or more instructions, when executed by the at least one processor individually or collectively, may cause the electronic device to convert pieces of second RGB data corresponding to the pieces of second color data into pieces of second xyY data.

The one or more instructions, when executed by the at least one processor individually or collectively, may cause the electronic device to obtain a first coordinate value expressed by a first x value and a first y value representing a color space among the first xyY data and second coordinate values expressed by second x values and second y values representing color spaces among the pieces of second xyY data,

The one or more instructions, when executed by the at least one processor individually or collectively, may cause the electronic device to identify screen setting information corresponding to a second coordinate value that is closest to the first coordinate value from among the second coordinate values.

The one or more instructions, when executed by the at least one processor individually or collectively, may cause the electronic device to, when the screen of the second display device is set based on the identified screen setting information, perform screen calibration so that the screen of the second display device becomes the same as the screen of the first display device in terms of color or brightness.

A plurality of screens corresponding to the plurality of screen setting information may have different ranges of adjustable color coordinates.

The one or more instructions, when executed by the at least one processor individually or collectively, may cause the electronic device to control the second display device so that the screen setting information of the second display device is changed, by changing information about at least one of a picture mode, a color temperature, or a color space included in a screen menu of the second display device.

An operation method of an electronic device, according to an embodiment of the disclosure, may include receiving first color data of a screen of a first display device from an external device.

The operation method of an electronic device, according to an embodiment of the disclosure, may include controlling the second display device to change screen setting information of a second display device, through an input/output interface.

The operation method of an electronic device, according to an embodiment of the disclosure, may include, based on a change in the screen setting information of the second display device, receiving pieces of second color data of screens corresponding to a plurality of screen setting information of the second display device from the external device.

The operation method of an electronic device, according to an embodiment of the disclosure, may include identifying one of the plurality of screen setting information, based on the first color data and the pieces of second color data.

The operation method of an electronic device, according to an embodiment of the disclosure, may include controlling the second display device through the input/output interface so that the screen of the second display device is set based on the identified screen setting information.

The first color data and the pieces of second color data may be obtained by a camera included in the external device.

The operation method of an electronic device, according to an embodiment of the disclosure, may include controlling the first display device and the second display device to display same reference patterns.

The operation method of an electronic device, according to an embodiment of the disclosure, may include controlling the first display device through the input/output interface so that an object guiding a shooting area is displayed on the screen of the first display device.

The operation method of an electronic device, according to an embodiment of the disclosure, may include, based on the first color data being obtained, controlling the first display device through the input/output interface so that the display of the object is terminated or properties of the object are changed.

The operation method of an electronic device, according to an embodiment of the disclosure, may include identifying screen setting information corresponding to second color data that is most similar to the first color data from among the pieces of second color data.

The first color data and the pieces of second color data may include RGB data or xyY data.

The operation method of an electronic device, according to an embodiment of the disclosure, may include converting first RGB data corresponding to the first color data into first xyY data.

The operation method of an electronic device, according to an embodiment of the disclosure, may include converting pieces of second RGB data corresponding to the pieces of second color data into pieces of second xyY data.

The operation method of an electronic device, according to an embodiment of the disclosure, may include obtaining a first coordinate value expressed by a first x value and a first y value representing a color space among the first xyY data and second coordinate values expressed by second x values and second y values representing color spaces among the pieces of second xyY data.

The operation method of an electronic device, according to an embodiment of the disclosure, may include identifying screen setting information corresponding to a second coordinate value that is closest to the first coordinate value from among the second coordinate values.

The operation method of an electronic device, according to an embodiment of the disclosure, may include, when the screen of the second display device is set based on the identified screen setting information, performing screen calibration so that the screen of the second display device becomes the same as the screen of the first display device in terms of color or brightness.

The electronic device according to an embodiment of the disclosure may improve the efficiency and accuracy of calibration by optimizing a screen menu of a target display device to color data of a screen of a first display device and then performing screen calibration.

The electronic device according to an embodiment of the disclosure may provide a function of automatically performing screen calibration, thereby enabling a user to easily perform calibration and saving time required for calibration.

The electronic device according to an embodiment of the disclosure may improve the efficiency and accuracy of calibration, even when performing screen calibration of display devices of different manufacturers or models.

An operation method of an electronic device according to an embodiment of the disclosure may be embodied as program commands executable by various computer means and may be recorded on a computer-readable recording medium. The computer-readable recording medium may include program commands, data files, data structures, and the like separately or in combinations. The program commands to be recorded on the recording medium may be specially designed and configured for the disclosure or may be well-known to and usable by one of ordinary skill in the art of computer software. Examples of the computer-readable recording medium include a magnetic medium such as a hard disk, a floppy disk, or a magnetic tape, an optical medium such as a compact disk-read-only memory (CD-ROM) or a digital versatile disk (DVD), a magneto-optical medium such as a floptical disk, and a hardware device specially configured to store and execute program commands such as a ROM, a random-access memory (RAM), or a flash memory. Examples of the program commands are high-level language codes that can be executed by a computer by using an interpreter or the like as well as machine language codes made by a compiler.

The operation method of a display device, according to embodiments of the disclosure, may be provided by being included in a computer program product. The computer program product, which is a commodity, may be traded between sellers and buyers.

The computer program product may include a software (S/W) program and a computer-readable storage medium having the S/W program stored thereon. For example, the computer program product may include a product in the form of a software program (e.g., a downloadable app) that is electronically distributed through the manufacturer of an electronic device or an electronic market (e.g., Google Play Store, AppStore). For electronic distribution, at least a portion of the S/W program may be stored on a storage medium or may be created temporarily. In this case, the storage medium may be a server of a manufacturer, a server of an electronic market, or a storage medium of a relay server for temporarily storing an SW program.

The computer program product may include, in a system including a server and a client device, a storage medium of the server or a storage medium of the client device. Alternatively, if there is a third device (e.g., a smartphone) in communication with the server or client device, the computer program product may include a storage medium of the third device. Alternatively, the computer program product may include the S/W program itself transmitted from the server to the client device or the third device, or transmitted from the third device to the client device.

In this case, one of the server, the client device, and the third device may execute the computer program product to perform the methods according to the disclosed embodiments. Alternatively, at least two of the server, the client device, and the third device may execute the computer program product to distribute and perform the methods according to the disclosed embodiments.

For example, a server (e.g., a cloud server or an artificial intelligence server) may execute a computer program product stored on a server to control a client device communicating with the server to perform the methods according to the disclosed embodiments.

While example embodiments of the disclosure have been described with reference to the figures, it will be understood by those of ordinary skill in the art that various changes in form and details may be made therein without departing from the spirit and scope as defined by the following claims.

What is claimed is:

1. An electronic device comprising:
a communicator configured to communicate with an external device;
an input/output interface configured to perform communication with a first display device and a second display device;
memory storing one or more instructions; and
at least one processor including processing circuitry,
wherein the one or more instructions, when executed by the at least one processor individually or collectively, cause the electronic device to:
control the communicator to receive first color data of a screen of the first display device from the external device;
control the second display device to iteratively change screen setting information of the second display device through the input/output interface;
for each change in the screen setting information of the second display device, control the communicator to receive a piece of second color data of a screen of the second display corresponding to a piece of screen setting information of a plurality of pieces of screen setting information of the second display device from the external device;
identify a piece of screen setting information from among the plurality of pieces of screen setting information based on the first color data and the pieces of second color data; and
control the second display device through the input/output interface so that the screen of the second display device is set based on the identified piece of screen setting information.

2. The electronic device of claim 1, wherein the first color data and the pieces of second color data are obtained by a camera included in the external device.

3. The electronic device of claim 1, wherein the one or more instructions, when executed by the at least one processor individually or collectively, further cause the electronic device to control the first display device and the second display device through the input/output interface to display same reference patterns.

4. The electronic device of claim 1, wherein the input/output interface comprises a high-definition multimedia interface (HDMI) port or a display port (DP).

5. The electronic device claim 1, wherein the one or more instructions, when executed by the at least one processor individually or collectively, further cause the electronic device to:
control the first display device through the input/output interface so that an object guiding a shooting area is displayed on the screen of the first display device; and
based on the first color data being received, control the first display device through the input/output interface so that the display of the object is terminated or properties of the object are changed.

6. The electronic device claim 1, wherein the identified piece of screen setting information corresponds to a piece of second color data, among the pieces of second color data, that is most similar to the first color data.

7. The electronic device of claim 1, wherein the first color data comprises a first RGB data,
each piece of second color data comprises a piece of second RGB data, and
the one or more instructions, when executed by the at least one processor individually or collectively, further cause the electronic device to:
convert the first RGB data corresponding to the first color data into a first xyY data; and
convert each piece of second RGB data corresponding to the pieces of second color data into a piece of second xyY data.

8. The electronic device of claim 7, wherein the first xyY data comprises a first coordinate value expressed by a first x value and a first y value associated with a color space,
each piece of the second xyY data comprises a second coordinate value expressed by a second x value and a second y value associated with the color space, and
the identified piece of screen setting information corresponds to the second coordinate value that is closest to the first coordinate value.

9. The electronic device of claim 1, wherein the one or more instructions, when executed by the at least one processor individually or collectively, further cause the electronic device to, based on the screen of the second display device being set based the identified piece of screen setting information, perform screen calibration so that the screen of the second display device and the screen of the first display device have substantially identical color or brightness.

10. The electronic device of claim 1, wherein a plurality of screens corresponding to the plurality of pieces of screen setting information have different ranges of adjustable color coordinates.

11. The electronic device of claim 1, wherein the screen setting information of the second display device is changed by changing information about at least one of a picture mode, a color temperature, or a color space included in a screen menu of the second display device.

12. An operation method of an electronic device, the operation method comprising:
receiving first color data of a screen of a first display device from an external device;
controlling, through an input/output interface, a second display device to iteratively change screen setting information of a second display device;
for each change in the screen setting information of the second display device, receiving a piece of second color data of a screen of the second display corresponding to a piece of screen setting information of a plurality of pieces of screen setting information of the second display device from the external device;
identifying a piece of screen setting information from among the plurality of pieces of screen setting information based on the first color data and the pieces of second color data; and
controlling the second display device through the input/output interface so that the screen of the second display device is set based on the identified piece of screen setting information.

13. The operation method of claim 12, wherein the first color data and the pieces of second color data are obtained by a camera included in the external device.

14. The operation method of claim 12, further comprising controlling the first display device and the second display device to display same reference patterns.

15. The operation method of claim 12, further comprising:
controlling the first display device through the input/output interface so that an object guiding a shooting area is displayed on the screen of the first display device; and
based on the first color data being obtained, controlling the first display device through the input/output interface so that the display of the object is terminated or properties of the object are changed.

16. The operation method of claim 12, wherein the identified piece of screen setting information corresponds to a piece of second color data, among the pieces of second color data, that is most similar to the first color data.

17. The operation method of claim 12, wherein
the first color data comprises a first RGB data,
each piece of second color data comprises a piece of second RGB data, and
the operation method further comprises:
converting the first RGB data corresponding to the first color data into first xyY data; and
converting each piece of second RGB data corresponding to the pieces of second color data into a piece of second xyY data.

18. The operation method of claim 17, wherein the first xyY data comprises a first coordinate value expressed by a first x value and a first y value associated with a color space,
each piece of the second xyY data comprises a second coordinate value expressed by a second x values and a second y values associated with the color space, and
the identified piece of screen setting information corresponds to the second coordinate value that is closest to the first coordinate value.

19. The operation method of claim 12, further comprising, based on the screen of the second display device being set based on the identified screen setting information, performing screen calibration so that the screen of the second display device and the screen of the first display device have substantially identical color or brightness.

20. A non-transitory computer-readable recording medium having recorded thereon a program that is executed by at least one processor of an electronic device to perform the operation method of claim 12.
